(19) United States
(12) Patent Application Publication
(10) Pub. No.: US 2008/0062885 A1
(43) Pub. Date: Mar. 13, 2008

(54) MAJOR PROBLEM REVIEW AND TRENDING SYSTEM

(75) Inventors: Carroll W. Moon, Matthews, NC (US); Neal R. Myerson, Seattle, WA (US); Susan Pallini, Windham, NH (US); Gary J. Baxter, Redmond, WA (US); Thomas D. Applegate, North Bend, WA (US); Darren C. Justus, New York, NY (US)

Correspondence Address: VIERRA MAGEN/MICROSOFT CORPORATION, 575 MARKET STREET, SUITE 2500, SAN FRANCISCO, CA, 94105, US

(73) Assignee: MICROSOFT CORPORATION, Redmond, WA (US)

(21) Appl. No.: 11/531,250

(22) Filed: Sep. 12, 2006

(51) Int. Cl. H04J 1/16

(52) U.S. Cl. 370/244

(57) ABSTRACT

Technology is disclosed for implementing a major problem review process. Incidents are recorded in a common data schema and the data is then used to facilitate an IT organization's major problem review process. Reporting is provided on the data in a format that allows trend information to be readily compiled. The format allows tracking both a primary root cause and an exacerbating cause of an incident or problem. Incidents can be recorded in relation to a group of elements having a common characteristic. The technology includes facilities for tracking downtime minutes by server, service, and database.

### BACKGROUND

Organizations are increasingly dependent upon IT to fulfill their corporate objectives. There is more pressure than ever on companies to employ a well structured information technology (IT) management process. This is due to a number of factors, including the need to satisfy external auditors performing IT audits to ensure regulatory compliance.

The IT Infrastructure Library (ITIL) provides a set of best practices for IT service processes to provide effective and efficient services in support of the business.

One component of a good IT management process is problem management. The problem management process seeks to minimize the adverse impact of incidents and problems resulting from errors within the IT infrastructure, and to prevent the recurrence of incidents related to those errors. Proactive problem management prevents incidents from occurring by identifying weaknesses or errors in the infrastructure and proposes applicable resolutions. This includes change and release management of upgrades and fixes. Reactive problem management identifies the root cause of past incidents and proposes improvements and resolutions.

Several ITIL definitions are useful in understanding problem review. An incident is any event, not part of a standard service operation, which causes, or may cause, an interruption or reduction in quality of service. A problem is a condition characterized by multiple incidents exhibiting common symptoms, or a single significant incident for which the root cause is unknown. A known error is a problem for which the root cause and a workaround have been determined.

There is no single process which covers all problem management. Problem management processes may include problem identification and recording in which parameters defining the problem are defined, such as reoccurring incident symptoms or service degradation threatening service level agreements. Problem characteristics are recorded within a known problem database. Problems may classified by category, impact, urgency, priority and status. Data obtained from various processes and locations may then be analyzed to diagnose the root cause of the problem. Once the root cause has been determined, the problem has been turned into a known error and is passed to the change management process.

Major problem reviews following outages look for opportunities to improve by avoiding similar outages and/or by minimizing the impact of similar outages in the future. Process theory also covers the concept of trending outages. Even where guidance on how to accomplish such best practices is available, there is no discreet guidance on how to accomplish these review or trending, or to make the best practices readily applicable, especially in distributed environment.

Existing incident and problem management tools in the market today do not automatically facilitate deep data gathering. Often, the categorizations are vague, and do not accurately describe the service impacted. Thus, data that comes from these tools is often not useful for making decisions.

### SUMMARY

Technology is disclosed for implementing a major problem review process. Incidents are recorded in a common data schema and the data is then used to facilitate an IT organization's major problem review process. Reporting is provided on the data in a format that allows trend information to be readily compiled. The format allows tracking both a primary root cause and an exacerbating cause of an incident or problem. Incidents can be recorded in relation to a group of elements having a common characteristic. The technology includes facilities for tracking downtime minutes by server, service, and database.

In one aspect, the technology includes a method for reviewing problems in a computing environment. The IT organization is organized into a logical representation characterized by groups of elements sharing at least one common characteristic. Data is identified for each incident affecting one or more elements in the computing environment in relation to at least one group of elements. The data is then stored each incident in a common record format which includes an association of the incident with other groups of elements affected by the change.

In addition, a computer-readable medium having stored thereon a data structure is provided. The structure includes a first data field containing data identifying an incident and at least a second data field associated with the first data field identifying a group of components of an IT infrastructure associated with the incident. At least a third data field is provided to identify a root cause for the incident, each root cause being classified as a people cause, process cause or technology cause.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 depicts a flow chart showing a first method for implementing a major problem review process in accordance with the technology discussed herein.

FIG. 2 is a block diagram depicting the interaction between a system implementing the technology and a change and review process.

FIG. 3 is a block diagram of an exemplary computing environment disclosed in FIG. 4A.

FIG. 4 depicts a user interface input form in accordance with the technology disclosed herein.

FIG. 5 depicts a first user interface view in accordance with the technology disclosed herein.

FIG. 6 depicts a second user interface view in accordance with the technology disclosed herein

FIG. 7 depicts a downtime report table included in the reporting options of the technology disclosed herein.

FIG. 8 depicts a graph of planned and unplanned trends which may be provided by the reporting features of the present technology.

FIG. 9 depicts an analysis report table which may be provided by the reporting features of the present technology.

FIGS. 10-18 depict analysis graphs which may be provided by the reporting features of the present technology.

### DETAILED DESCRIPTION

Technology is disclosed herein for implementing a major problem review process. In one aspect, incidents are recorded in a common data schema and the data is then used to facilitate an IT organization's major problem review process. Reporting is provided on the data in a format that allows trend information to be readily compiled. The format allows tracking both a primary root cause and an exacerbating cause of an incident or problem. Incidents can be recorded in relation to a group of elements having a common characteristic, which allows incidents to be categorized outages on any number of basis, including, for example, a service-by-service basis. The technology includes facilities for tracking downtime minutes by server, service, and database. Still further, the technology allows for recording and tracking action items related to major problems, and for tracking actions and recommendations in relation to people, process, and technology separately.

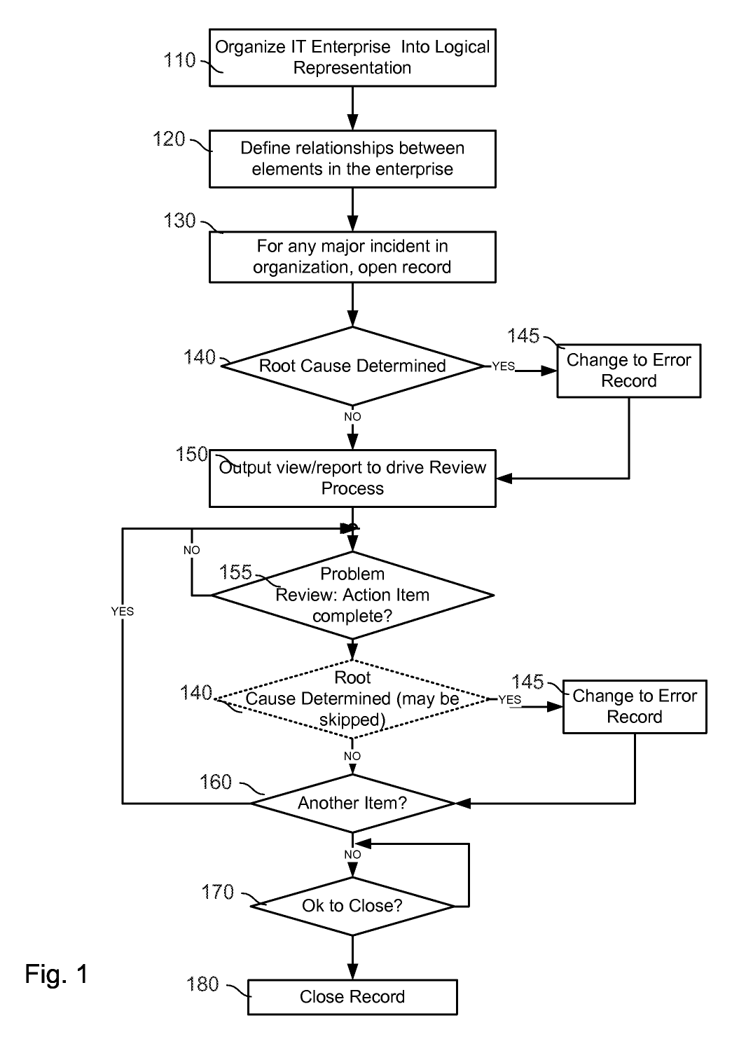

FIG. 1 illustrates a method in accordance with the technology disclosed herein for implementing a major problem review analysis with respect to an IT enterprise. In general, an IT enterprise may consist of one or more distributed computing devices connected to one or more public and private networks. The IT environment of the enterprise includes multiple information technology services provided on one or more hardware systems. The hardware systems may be distributed and networked. Services provided in the environment include, for example, file transfer systems, electronic mail systems, back-up systems, firewalls, databases, and the like. Services on the system can connect to interoperate with, and/or rely on many other services. The major problem review covers incidents which affect server, application and service downtime.

At step 110, the IT enterprise is organized into logical categories. In one embodiment, this may include defining any number of categories, groups, or commonalities amongst hardware, applications and services within the organization. The grouping may be performed in any manner. One example of such a grouping is disclosed in U.S. patent application Ser. No. 11/343,980 entitled “Creating and Using Applicable Information Technology Service Maps,” Inventors Carroll W. Moon, Neal R. Myerson and Susan K. Pallini filed Jan. 31, 2006, assigned to the assignee of the instant application and fully incorporated herein by reference. In the service map categorization, common elements among various distributed systems within an organization are determined and used to track changes and releases based on the common elements, rather than, for example, physical systems individually. In the aforementioned application Ser. No. 11/343,980, a service map defines a taxonomy of level of detail of competing components in the information technology infrastructure is defined. The technology service method used to simplify information technology infrastructure management. The service map maps a corresponding information technology infrastructure with a specified level of detail and represents dependencies between services and streams included in the technology service map. Although the service map of application Ser. No. 11/343,980 is one method of organizing an IT infrastructure, other categorical relationships may be utilized.

At step 120, relationships between elements in the taxonomy are defined. Step 120 defines the relationships between the various elements in taxonomy so the changes to one or more categories or reflected in other category or elements residing in sub categories. For example, one might define a common group comprising services, and a group of services comprising the messaging service. Another group may be defined by exchange mail servers, and still other groups defined by the particular types of hardware configurations within the enterprise. At step 120, one can define the relationships between that the mail servers as a subcategory of the messaging service, and define which hardware configurations are associated with exchange servers.

In accordance with the technology discussed herein, problems entered for review may be recorded in relationship to one or more of the groups within the taxonomy, rather than to individual machines or elements within the taxonomy. Hence, a major problem record entered in accordance with the technology discussed herein may relate the problem to all elements sharing a common characteristic (hardware, application, etc.) with the element which experiences the problem. For example, if a mail server goes down, a major problem review record will include an identifier for the server and one or more groups in the taxonomy (i.e. which applications are on the server, where the server is located, etc.) to which the problem is related, allowing trending data to be derived. Reports may then be provided which indicate which percentage of major problems experienced related to email. Similarly, if one were to define a category of a hardware model of a particular server type, problems to that particular hardware model might affect one or more categories of applications or services provided by the hardware model.

In accordance with the foregoing, any incident in the IT enterprise is tracked by first opening a major problem review (MPR) record at step 130. At step 130, the record may include data on the relationship between various groups in the taxonomy. As discussed below, this MPR record is stored in a common schema which can be used to drive the problem review process. The MPR record is the first stage of a review and is generally initiated by an IT administrator. Additional elements in the record may include storing whether root cause is known for the incident. At step 140, when entering the record (or at a later time), a determination is made as to whether the root cause of an incident is known. If so, then a flag in the record is set at step 145 indicating that the problem record is now a known error record, and may be viewed and reported on separately in the view and reporting aspects of the present technology.

Major problem review at steps 150-180 may occur using the technology described herein.

At step 150, the MPR record may be output to a view or report to drive a major problem review process. The major problem review process may include investigation and diagnosis of incidents where there are no known errors or known problems. In this case, the incident must be further investigated and action items for the incident need to be tracked.

As part of the major problem review process, one or more action items may be identified in the MPR record. At step 155, during the review process, a determination is made as to whether any action items currently exist for the Incident record. One such action item may be to identify the root cause (step 140a) during the review process. Other action items may be generated based on the motivation to restore service as quickly as possible by rebooting the system without determining the root cause. Once a solution is found, the issue is resolved by restoring services to normal operation. Once an action item is complete, if there are no further items at step 160, it may be determined that it is acceptable to close the record at step 170 and the record may be closed at step 180.

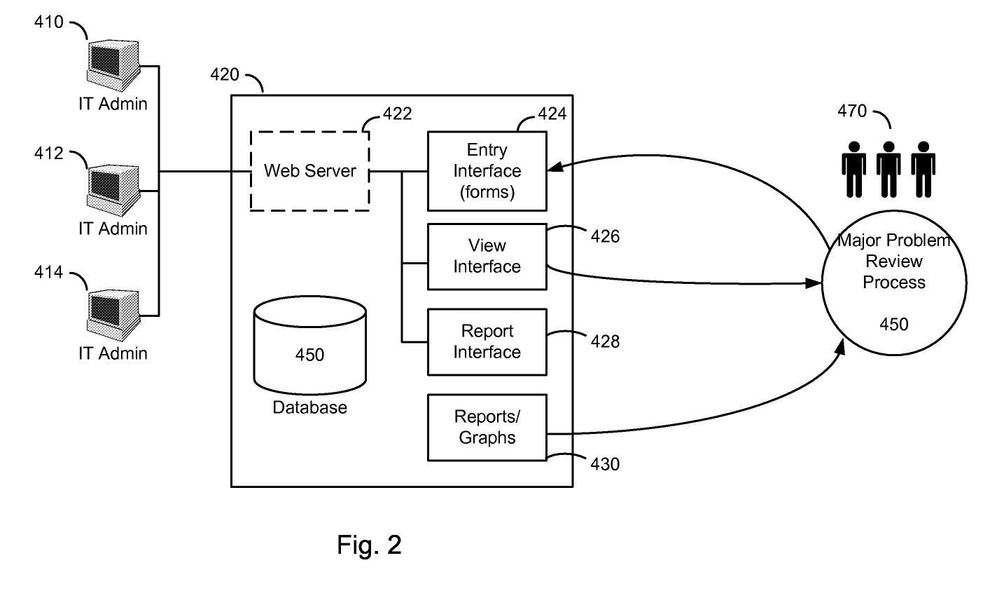

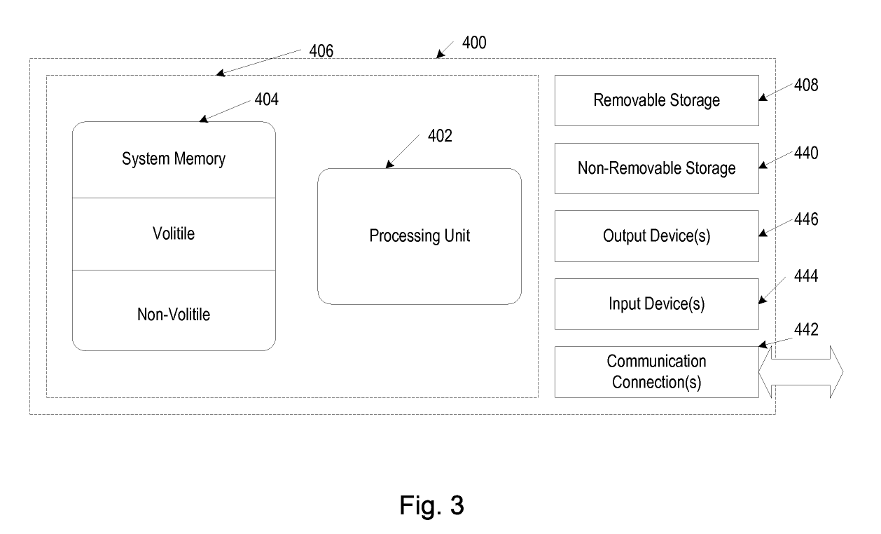

FIGS. 2 and 3 illustrate a system for implementing the method disclosed in FIG. 1. A computing system 420 may include, for example, data store 450 and application programs which provide an entry interface 424, a view interface 426, a report interface 428, and reports or graphs 430. The interfaces may be provided by computer-executable instructions, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Data concerning incidents is entered into the data base 450 as defined in table 1 below. In one embodiment, the data base 450 may comprise a Microsoft SharePoint server, but any type of database may be utilized. In accordance with the method of FIG. 1. IT administrators 410, 412, 414 interact with the entry interface 424 to enter MPR records as discussed above. In one embodiment, a web server 422 may be optionally provided to provide the entry interface in a web browser on one or more computing devices of the IT administrators 410, 412, 414. Alternatively, the entry interface may be provided directly to the administrators by a dedicated processing application. It will be further understood that each administrator 410, 412, 414 may be operating on a separate computer or on computing device 420.

Once data is entered into the entry interface as discussed above with respect to step 130, a view in the view interface 426 is selectable by the administrators provides a means to view the MPR record, as discussed above with respect to step 150. Various examples of view interfaces are illustrated below. One or more views in the view interface may be reviewed by a committee 470 in accordance with the major problem review process 450. The report interface 428 allows the IT administrators to generate reports and graphs based on the data provided in the major problem record entry interface 424. Examples of information culled from the report interface are listed below.

Each computing system in FIG. 2 may comprise a system such as that illustrated in FIG. 3. With reference to FIG. 3, an exemplary system for implementing the invention includes a computing device, such as computing device 400. In its most basic configuration, computing device 400 typically includes at least one processing unit 402 and memory 404. Depending on the exact configuration and type of computing device, memory 404 may be volatile (such as RAM), non-volatile (such as ROM, flash memory, etc.) or some combination of the two. This most basic configuration is illustrated in FIG. 3 by dashed line 406. Additionally, device 400 may also have additional features/functionality. For example, device 400 may also include additional storage (removable and/or non-removable) including, but not limited to, magnetic or optical disks or tape. Such additional storage is illustrated in FIG. 3 by removable storage 408 and non-removable storage 440. Computer storage media includes volatile and nonvolatile, removable and non-removable media implemented in any method or technology for storage of information such as computer readable instructions, data structures, program modules or other data. Memory 404, removable storage 408 and non-removable storage 440 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 400. Any such computer storage media may be part of device 400.

Device 400 may also contain communications connection(s) 442 that allow the device to communicate with other devices. Communications connection(s) 442 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

Device 400 may also have input device(s) 444 such as keyboard, mouse, pen, voice input device, touch input device, etc. Output device(s) 446 such as a display, speakers, printer, etc. may also be included. All these devices are well know in the art and need not be discussed at length here.

It should be recognized that one or more of devices 400 may also make up an IT environment, and multiple configurations of devices may exist within the organization. This can be grouped and tracked in the organization and various organizations may have different configurations. Each configuration and the manner of tracking it is customizable.

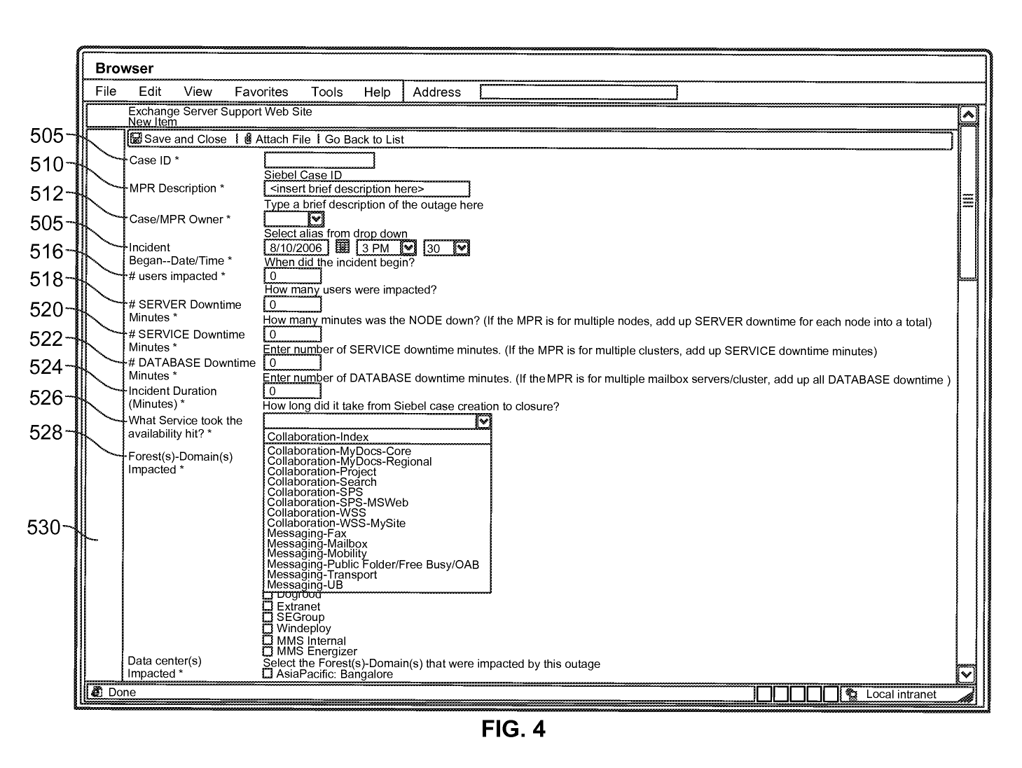

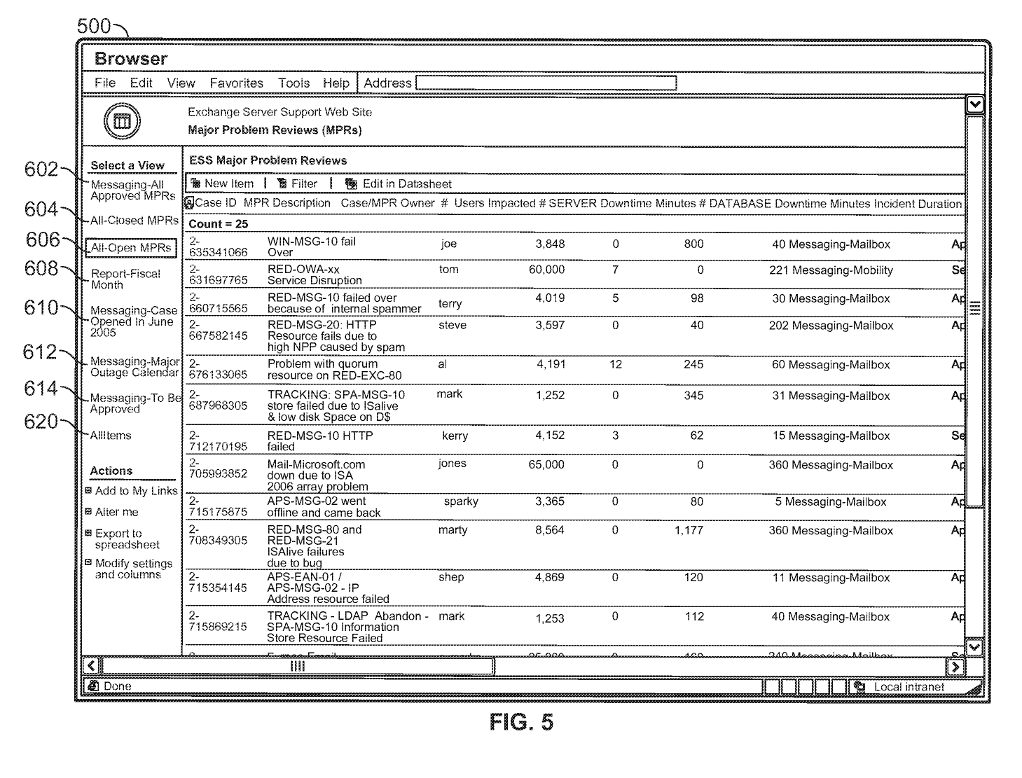

FIG. 4 illustrates one embodiment of an entry interface 424 provided in a window 500. In the embodiments shown in FIG. 5, window 500 is a web browser window which may be provided by web server 422 and rendered using any number of web-based programming languages. The entry interface 550 includes a plurality of data entry fields allowing an IT administrator to input data into the schema defined herein for a MPR record. As illustrated therein, interface 550 is an interface for a new item 502, but other interfaces may be provided to access data in the schema. Once data is entered into the form fields of interface 550, clicking the save and close radio button 520 will result in the data being stored in database 450. The data fields shown in FIG. 5 represent a subset of those in the schema list of Table 1, below. These include: a case ID 505, an item description 510, which may be a brief description of the change; the case/MPR owner 512, the incident start time 514, the number of users impacted 516; the number of server downtime minutes 518; the number of service downtime minutes 520; the number of database downtime minutes 522; the incident duration 524, which group (in this case a service) was affected (or “took the hit”) 526; and which domains and/or forests (groups of named servers) were impacted 518.

Table 1 lists the schema used with the technology described herein for identifying each major problem to be entered in the database 450. Table 1 includes a number of data items which are not shown in interface 502. However it will be understood that interface 502 may display all or subset of the data items. In one embodiment, a subset of data items is required to complete the entry of a MPR record into system 420.

Table 1 lists each of the elements in the schema, a description of the element, a type of element data which is recorded, and any given options for the data item. Many of the elements in the table are self-explanatory. It should be recognized that the fields listed in Table 1 are exemplary and in various embodiments, not all fields may be used or additional fields may be used.

TABLE 1

| Field | Description | Type | Options |
|---|---|---|---|
| Unique Identifier | Unique ID (primary key) | Number-auto- | n/a |
| | | generated | |
| Case ID | Insert case number from | Text-25 | n/a |
| | normal incident/problem | characters | |
| | management tool | | |
| MPR | Brief description of the outage | Text-255 | n/a |
| Description | | characters | |
| Case/MPR | Who is accountable for | Drop-down | All possible |
| Owner | driving this MPR? | list | owners should be |
| | | | listed |
| Incident | Date/Time outage began | Date/time | n/a |
| Began- | | | |
| Date/Time | | | |
| # users | How many users were | Number | n/a |
| impacted | impacted? | | |
| # server | How many server | Number | n/a |
| downtime | downtime minutes (how | | |
| minutes | long was the physical | | |
| | server down?) | | |
| # service | How many service | Number | n/a |
| downtime | downtime minutes | | |
| minutes | | | |
| # database | If a DB server/service | Number | n/a |
| downtime | failure, how many DBs? | | |
| minutes (if | Take # DBs * service | | |
| applicable) | downtime minutes | | |
| Incident duration | How long was the case | Number | n/a |
| (minutes) | open? How long to | | |
| | resolve? | | |
| What service | Based on the taxonomy | Drop down | Top level services |
| took the | such as “service map”. | | and supporting |
| availability hit? | Includes top-level | | services |
| | services as well as | | |
| | supporting services | | |
| Forest(s)- | Based on the taxonomy | Drop down | Forest(s)- |
| Domain(s) | such as “service map”. | | Domain(s) |
| impacted? | What forests and | | |
| | domains exist and were | | |
| | impacted | | |
| Datacenter(s) | Based on the taxonomy | Drop down | Datacenters |
| impacted? | such as “service map”. | | |
| | What datacenters were | | |
| | impacted | | |
| Initiating | Based on the taxonomy | Drop Down | App, hw, and |
| Technical | such as “service map”. | | setting streams |
| Service | What app stream, | | |
| Component | hardware steam, setting | | |
| | stream caused the | | |
| | outage regardless of the | | |
| | root causes | | |
| Recurring | Yes/No; determine | Boolean | Yes/No |
| Issue? | metric on the | | |
| | effectiveness of Error | | |
| | Control process | | |
| Detailed | What happened when? | Multiple lines | Bullet list that |
| Timeline | | of text - 50 | includes date/time, |
| | | lines of text | troubleshooting |
| | | | steps, etc |
| Root Cause | Yes/no; triggers problem | Boolean | Yes/No |
| Determined? | record to error record | | |
| Root Cause | Text description of root | Multiple lines | n/a |
| Description | cause | of text - 5 | |
| | | lines | |
| Primary Root | What was the cause of | Drop down | People |
| Cause | the outage? | | Process-Capacity |
| | | | & Performance |
| | | | Process-Change & |
| | | | Release |
| | | | Process- |
| | | | Configuration |
| | | | Process-Incident |
| | | | (& Monitoring) |
| | | | Process-Service |
| | | | Level Management |
| | | | (OLAs) |
| | | | Process-Third |
| | | | Party |
| | | | Technology-Bug |
| | | | Technology- |
| | | | Capacity |
| | | | Technology- |
| | | | Dependency(see |
| | | | causal stream) |
| | | | Technology- |
| | | | Hardware Failure |
| | | | Unknown |
| Exacerbating | What, if anything, | Drop down | n/a |
| Root Cause | exacerbated the outage? | | People |
| | | | Process-Capacity |
| | | | & Performance |
| | | | Process-Change & |
| | | | Release |
| | | | Process- |
| | | | Configuration |
| | | | Process-Incident |
| | | | (& Monitoring) |
| | | | Process-Service |
| | | | Level Management |
| | | | (OLAs) |
| | | | Process-Third |
| | | | Party |
| | | | Technology-Bug |
| | | | Technology- |
| | | | Capacity |
| | | | Technology- |
| | | | Dependency(see |
| | | | causal stream) |
| | | | Technology- |
| | | | Hardware Failure |
| % unplanned | What % due to | Drop down | 0 - (0%) |
| downtime due to | exacerbating root | | 1 - (25%) |
| exacerbating | cause? | | 2 - (50%) |
| root cause | | | 3 - (75%) |
| | | | 4 - (100%) |
| People | What people | Multiple lines | n/a |
| Recommendations | recommendations come | of text-5 lines | |
| | from this analysis? | | |
| Process | What process | Multiple lines | n/a |
| Recommendations | recommendations come | of text-5 lines | |
| | from this analysis? | | |
| Technology | What technology | Multiple lines | n/a |
| Recommendations | recommendations come | of text-5 lines | |
| | from this analysis? | | |
| Actions | Bulleted list of action | Multiple lines | n/a |
| | items with owner | of text-20 | |
| | | lines | |
| MPR Status | Is the MPR complete | Drop down | Open |
| | (i.e. all action items | | Closed |
| | complete) | | |
| Date/Time MPR | Date/Time MPR was | Date/Time | n/a |
| Closed | closed, if closed | | |

While many of the fields are self explanatory, further discussion of other fields follows.

The “unique identifier” field associates the unique identifier with each change request entry. The unique identifier may be auto generated upon entry of an item into the user interface.

The “description” item allows users to enter descriptive text regarding a brief description of the incident or problem.

The “# service downtime minutes”, “# server downtime minutes” and “# database downtime minutes” allow separate tracking of three important but distinct metrics. The tracking of these items separately in the schema allows a report to be generated to illustrate the true affect of a major problem on each of these separate data points. To illustrate the difference between server, service and database downtime, consider a case of a single mailbox server machine running, for example, Microsoft Exchange 2003, and having five databases. If the physical server is down for three hours, this would constitute three hours of server downtime, three hours of email service downtime, and fifteen hours (three hours multiplied by five databases) of database downtime. Consider further that the mailbox server is paired with another mailbox server in a two node, fail over embodiment. If one of the two servers fails for three hours, and five minutes are required for the second server to take over, this would constitute three hours of server downtime, five minutes of fail over downtime (service downtime), and twenty-five minutes of database downtime (five minutes times five databases). Note that other metrics may be utilized. For example, another metric could be ‘user impact’ which is tracked in amounts of user downtime minutes. In this alternative, the value could be calculated as the number of users impacted multiplied by the number of service downtime minutes.

An advantage of the present technology is that each of these elements may be tracked separately and reported to the IT managers. Each metric measures a different effect on the business and end users of the services, as well as how well the IT organization is performing.

The “What Service Took the Availability Hit” field is an example of a field which tracks the event by a group of common elements that at a major problem may affect. Hence, “services” are one group which may be defined in accordance with step 110 for a particular IT organization. In other embodiments of the technology, groups may include services, application streams, hardware categories, and a “forest” or “domain” category. The “domain” may include a group of clients and servers under the control of one security database. As indicated in Table 1, each of these elements may be identified by field in the schema for tracking change and release elements. In various embodiments, one, two or all three of the service/stream/domain groups may be entered to define the relationship of any change and release record. Each of these elements may be defined in accordance with step 110 or in accordance with the teachings of U.S. patent application Ser. No. 11/343,980. The “What Service Took the Availability Hit” field identifies the service (messaging, etc.) which was affected by the incident.

The “forest-domain” and “data center” impacted fields allow further identification of the two additional groups of elements affected. Likewise, the “initiating technical service component” tracks whether an application stream, hardware stream, setting stream caused the incident. IN various embodiments, the incident may be tracked by service, forest/domain and datacenter together, or any one or more of the data items may be required.

In a further unique aspect of the present technology, both a primary and an exacerbating or secondary root cause are tracked by the technology. Hence, fields are provided to track primary and secondary or “exacerbating” root causes. Additionally, root causes are defined in terms of people, processes and technology. Processes include capacity & performance issues, change & release issues, configuration issues, incident (& monitoring) issues, service level management (SLA) issues, and third party issues. Technology issues can include bugs, capacity, other service dependencies and hardware failures. This separate tracking of both primary and secondary root causes allows the major problem review process to drill down into each root cause to determine further granularity of the root cause issue. Consider a case where a server in a remote location managed by a remote IT administrator goes down and is down for two hours. A primary root cause of the failure may be a bug in the software on the server, but the server could have been rebooted in 15 minutes had the administrator been on site with the server. In this case the secondary cause might be a process related cause in that the administrator was not required to be on site by the service level agreement at that facility. If the administrator was not trained to reboot the server, this would present a people issue, requiring further training of the individual.

In conjunction with the people, process and technology tracking of root and secondary causes, a “people recommendations” field, “process recommendations” field and “technology recommendations field may be used by the management review process to force problem reviewers to think through whether recommendations should be made in each of the respective root cause areas.

As noted above, in one embodiment, certain fields are required to be entered before a MPR record can be reviewed and/or closed. In one embodiment, the required fields include a Case ID, description, Case Owner, Incident begin time, number of users impacted, number of server, number of service downtime minutes, number of database downtime minutes, incident duration, service (or group) impacted, forest/domain impacted, datacenter impacted, initiating technical service component, and a detailed timeline. When the root cause is identified, additional required fields required include the primary root cause, the secondary root cause the percentage of downtime minutes due to the secondary root cause, process recommendations, technology recommendations, action items and MPR record status.

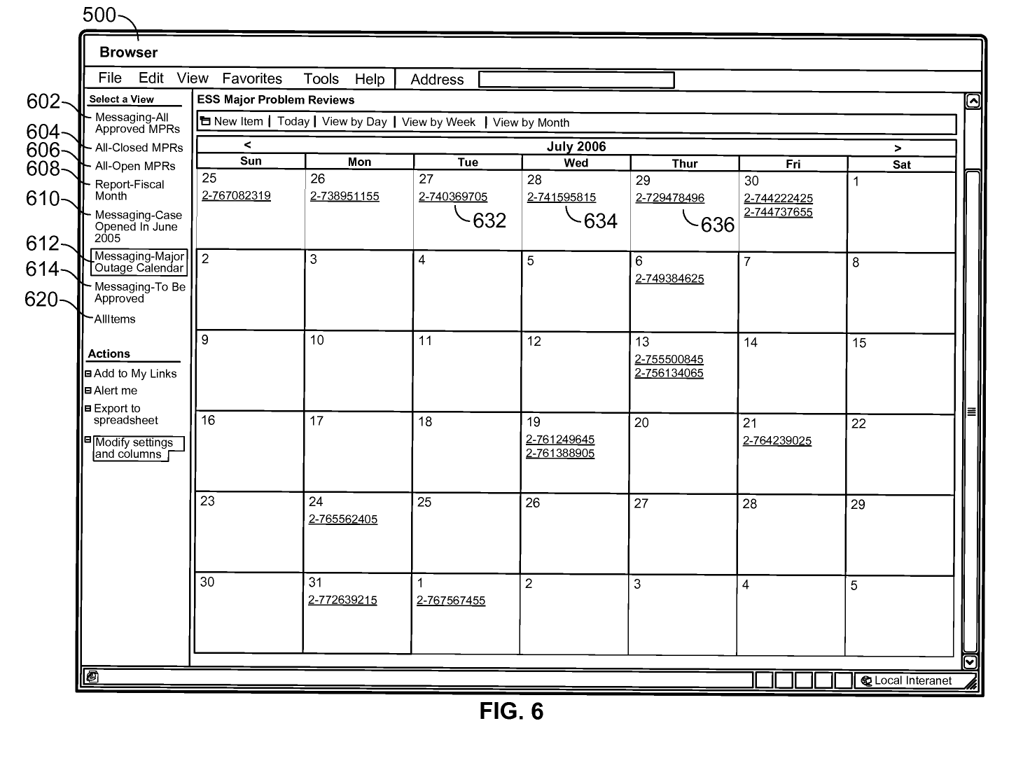

Different types of views, including calendar and list views, may be provided. FIG. 5 shows one of a number of exemplary views 602, 604, 606, 608, 610, 612, 614, 620 which may be selected by a user by clicking on one of the hyperlinks presented in the select a view section of the view interface 500 shown in FIG. 6. The “all open NPRs” view 604 lists all open NPR records which are open and awaiting review. The view provides column-wise lists of the case I.D., description, owner, the number of users impacted, percentage of server downtime minutes, number of database downtime minutes, and incident duration as well as the indication of which service took the availability hit. It will be recognized that other calls may be provided in this view. Each of the columns is sortable.

A calendar view such as that shown in FIG. 6 may also be provided. As illustrated in FIG. 6, each view may be provided in a browser window 500. Each view is selected from a linked list of views 600, 602, 604, 606, 608, 610, 612, 614, 620. Alternative mechanisms for selecting views may be utilized as will be recognized by one of average skill in the art. For example, where the database is provided in an SQL database, SQL queries or SQL Reporting Services may be used to generate views.

The calendar view “messaging-major outage calendar” 610 is a filtered view listing the major outages by case I.D. on the particular date they occurred, in this example, for the month July 2006. This is useful for determining whether a number of occurrences happened on a particular day. It will be understood that each of the items in the calendar view shown in FIG. 6 including items 632, 634 and 636 may comprise a hyperlink which, when selected, return to record similar to that shown in FIG. 5, providing a detailed view of the change or release.

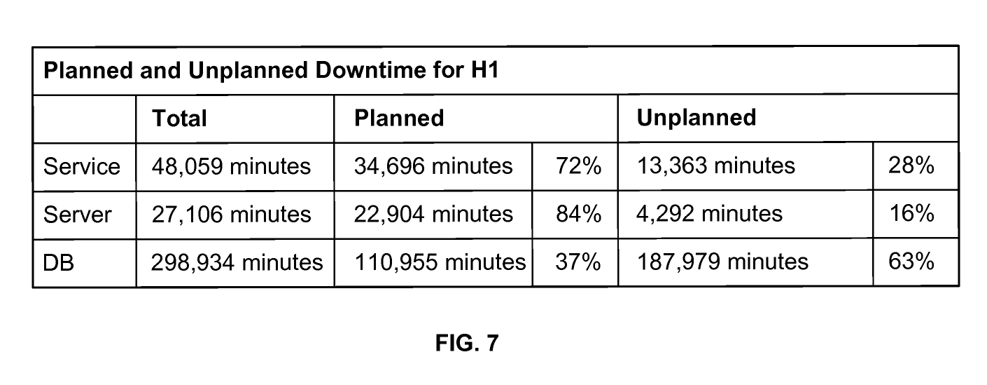

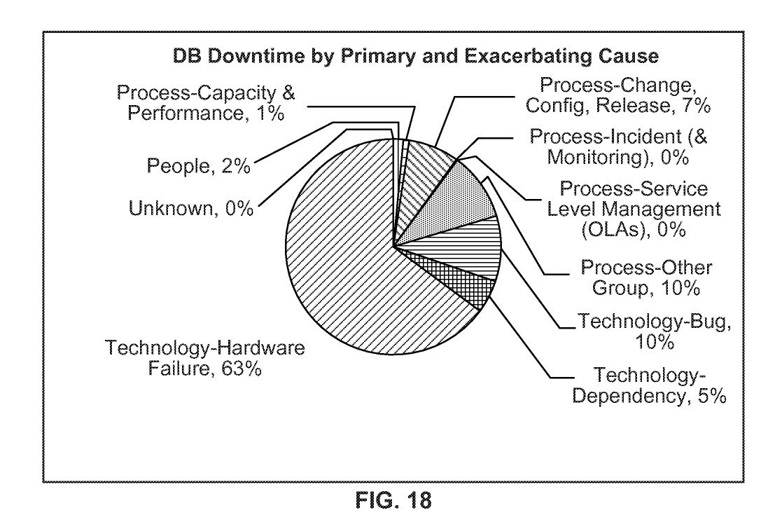

FIGS. 7 through 18 illustrate the graphs and reports which are capable of being generated by the report generator 430. Any one or more of these tables and graphs may be generated via the report interface 428 into a report 430 for use in a change and release management process of the organization. The report provides a “scorecard” for the IT department's effectiveness in managing major problem review. In one embodiment, all of the tables and graphs in FIGS. 7-18 are provided in a scorecard; in alternative embodiments, only some of the graphs may be utilized.

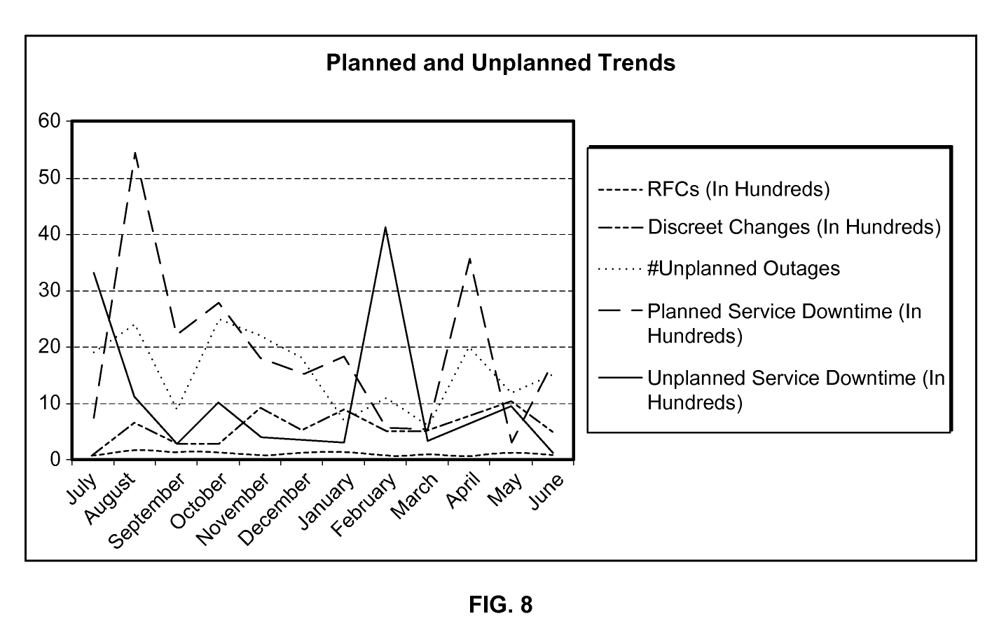

FIG. 7 shows a table of the planned and unplanned downtime for a particular service “H1” for a given period of time. FIG. 8 is a graph illustrating the planned and unplanned trends relative to the request for changes, discrete changes, the number of unplanned adages, and the planned and unplanned service downtime in hundreds of hours. Planned vs. unplanned trends allow the IT department to strive for all downtime to be planned. The ratio of planned to unplanned downtime is an indicator of how well an IT organization is meeting the needs of the organization. The graph culls data from the incident records as well as data on planned downtime which may be available to the IT organization in change and release management records. FIG. 8 builds upon the information available in FIG. 7. Looking at FIG. 7, one might ask whether there is a correlation between planned changes (planned downtime) and actual downtime. This can lead to further investigation of why all the planned downtime exists, what is causing the downtime and how many changes are necessary?

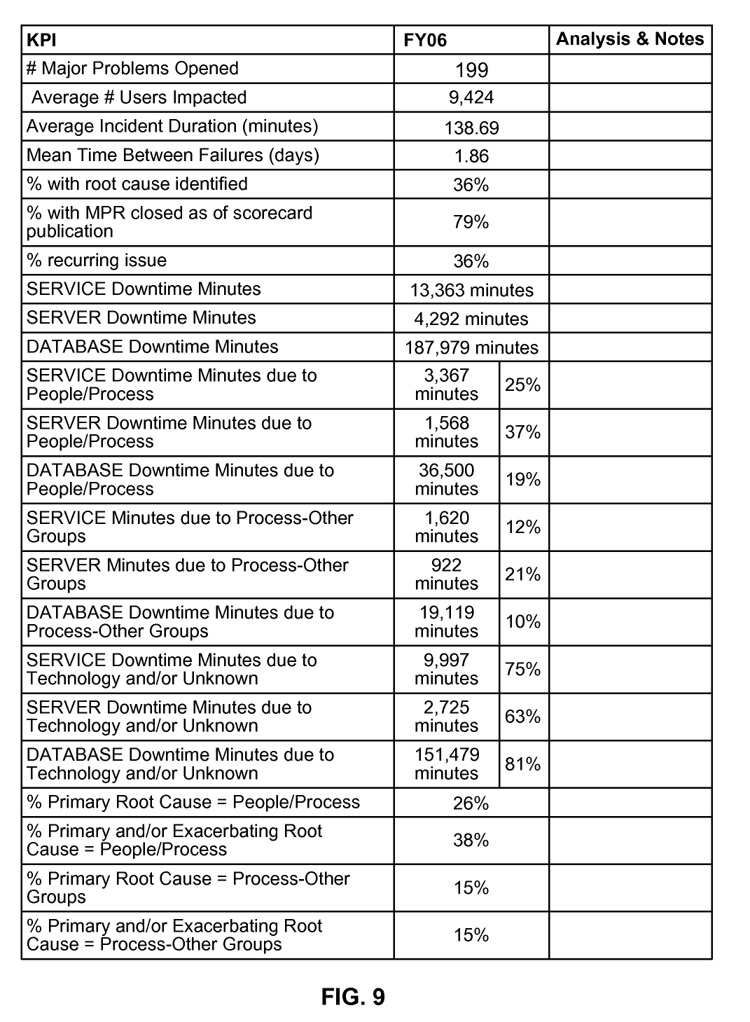

FIG. 9 is a table illustrating the types of reporting information which can be called from the database. With reference to FIG. 9, the “# Major Problems Opened” metric tracks the volume of major problems and provides a count of records for any given time period, in this case fiscal year 2006.

The “Average # users impacted” is a sum of users impacted for time period divided by the time period.

The “Average Incident Duration (minutes)” tracks outage duration and is the sum of incident duration for time period divided by a count of the time period. The “Mean Time Between Failures (days)” calculates the difference between the date/time opened for time period in days and average the difference. The MTBF and the duration are key metrics to IT service availability.

The “% with root cause identified” is a count of records with root cause identified checked for period divided by a count of MPRs in the period. This metric is indicative of the effectiveness of the IT department's problem control process.

The “% with MPR closed as of scorecard publication” is a count of records with MPR closed for period divided by count of MPRs per period. This metric is indicative of problem management effectiveness.

The “% recurring issue” metric is a count of records with recurring issues checked for period divided by count for period. This metric is indicative of the effectiveness of the error control process.

The “service downtime minutes,” “server downtime minutes,” and “DB downtime minutes” are sums of the respective downtime minutes for the period.

In a unique aspect of the technology, service, server and database downtime is reported relative to the root cause and exacerbating root cause of the problem, and the relative percentages of the root and exacerbating causes.

The “service downtime minutes due to people/process” is the total and percentage of service downtime minutes for period which is indicative of needed improvements for people or processes. This metric results from calculating the service downtime for each case due to a primary root cause (service downtime*(1−% due to exacerbating)) for each case and the downtime due to the exacerbating root cause for each case (service downtime*% due to exacerbating). The sum is the total of those columns where primary and/or exacerbating is attributable to people/process causes. This information is derived using the primary root cause and exacerbating cause drop down data from the records.

The “server downtime minutes due to people/process” and “DB downtime minutes due to people/process” are calculated in a similar manner.

The “Service downtime minutes due to process-other groups” shows the total of those columns where primary and/or secondary is attributable to process-other groups (using primary root cause and exacerbating cause drop down data). This is calculated by calculating service downtime for each case due to primary (service downtime*(1−% due to exacerbating)) for each case and also downtime due to exacerbating for each case (service downtime*% due to exacerbating). This is indicative of a need for better service level agreements and underpinning contracts.

The “Server downtime minutes due to Process-Other Groups” and “DB downtime minutes due to Process-Other Groups” are calculated in a similar manner.

Similarly, the scorecard provides a metric of “service downtime minutes due to Technology and/or Unknown”, “Server downtime minutes due to Technology and/or Unknown”, and “DB downtime minutes due to Technology and/or Unknown”, This is indicative of the need for technology improvements and problem control improvements.

The “% Primary Root Cause=People/Process” is a metric of the percentage of primary root causes which are due to people or process issues. It is derived by taking the number of cases having a primary root cause of a people/process divided by the number of MPRs for the period. The “% Primary and/or Exacerbating Root Cause=People/Process” is a metric of the percentage of primary or exacerbating root causes which are due to people or process issues. It is calculated by taking the number of MPRs with primary root cause of people/process and the number of exacerbating root cause of people/process, divided by the number of MPRs and count where the secondary cause does not equal ‘n/a’). Both are indicative of needed people/process improvements.

The “% Primary Root Cause=Process-Other Groups” and “% Primary and/or Exacerbating Root Cause=Process-Other Groups” are calculated in a similar manner for the process and “other groups” causes. These reports are indicative of need for better service level agreements and underpinning contracts. Similarly, the “% Primary Root Cause=Technology or Unknown” and “% Primary and/or Exacerbating Root Cause=Technology or Unknown” are calculated in a similar manner for the technology and “unknown” causes and are indicative of needed technology improvements and problem control improvements.

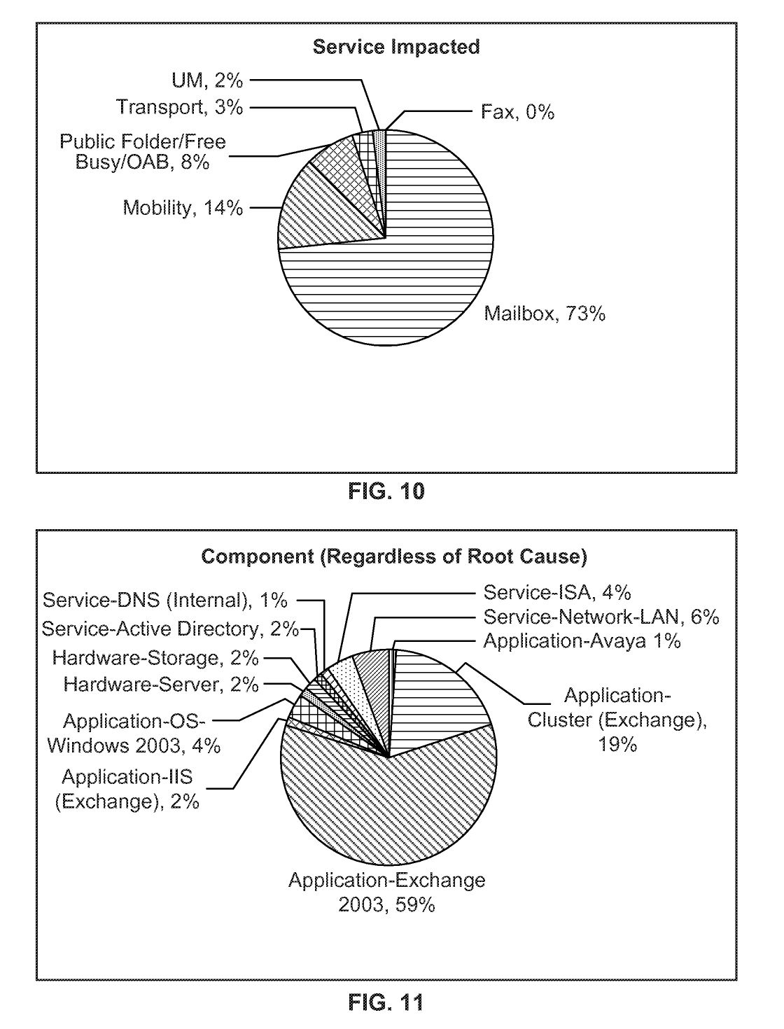

In addition to the metrics listed in the table of FIG. 9, a report may include one or more of the, graphs shown in FIGS. 10 through 18.

FIG. 10 is a graph illustrating the distribution of particular services impacted over a given time period. This graph allows IT departments to determine which services are most impacted by a major problem. As shown in FIG. 10, based on the data shown therein, 73 percent of the cases result from the mailbox service and would therefore merit further investigation.

FIG. 11 illustrates the distribution of which component initiating the outage, regardless of what the root cause for the outage was. In this case, 59 percent of the outages for a given period were the result of an Exchange application. Based on this data, the IT department would need to examine these Exchange issues in a more detailed manner and focus their attention on these particular components.

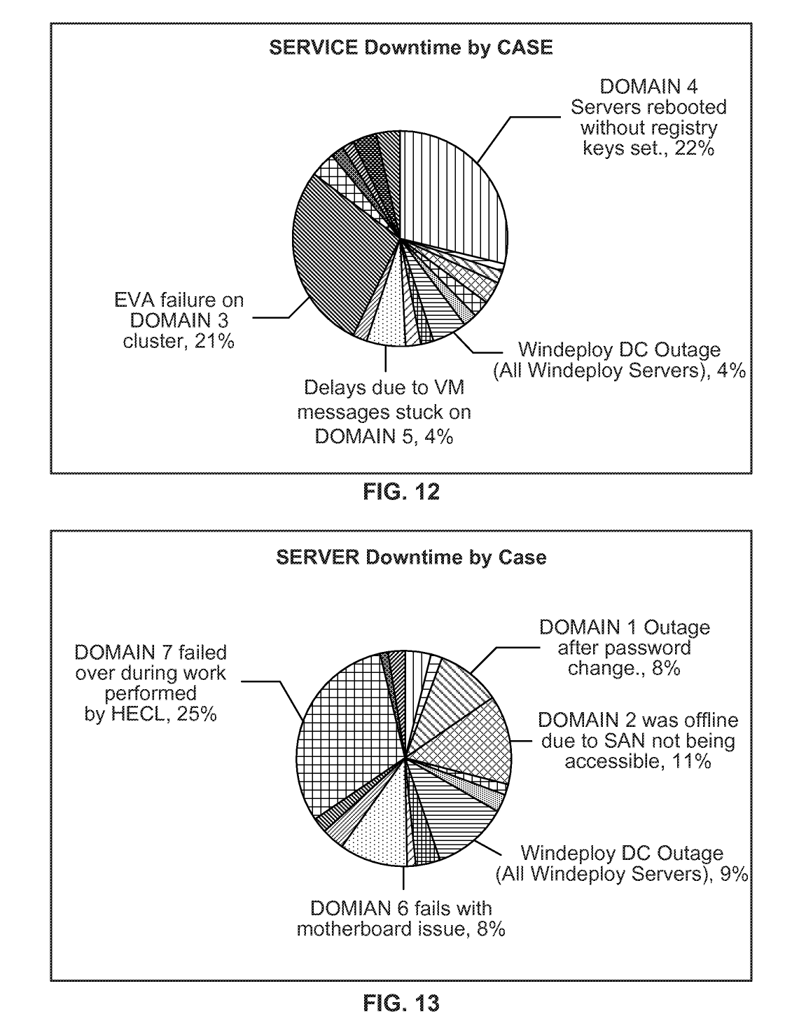

FIG. 12 is a graph listing the service down time by case which is a distribution in the service down time by outage in a particular period. In FIG. 12, percentages below four percent are not highlighted. FIG. 12 provides macro view of the service down time by case. Again, an IT department would want to go after the largest area in each time period to make sure that the issues occurring there do not recur, or have less impact during the next time period.

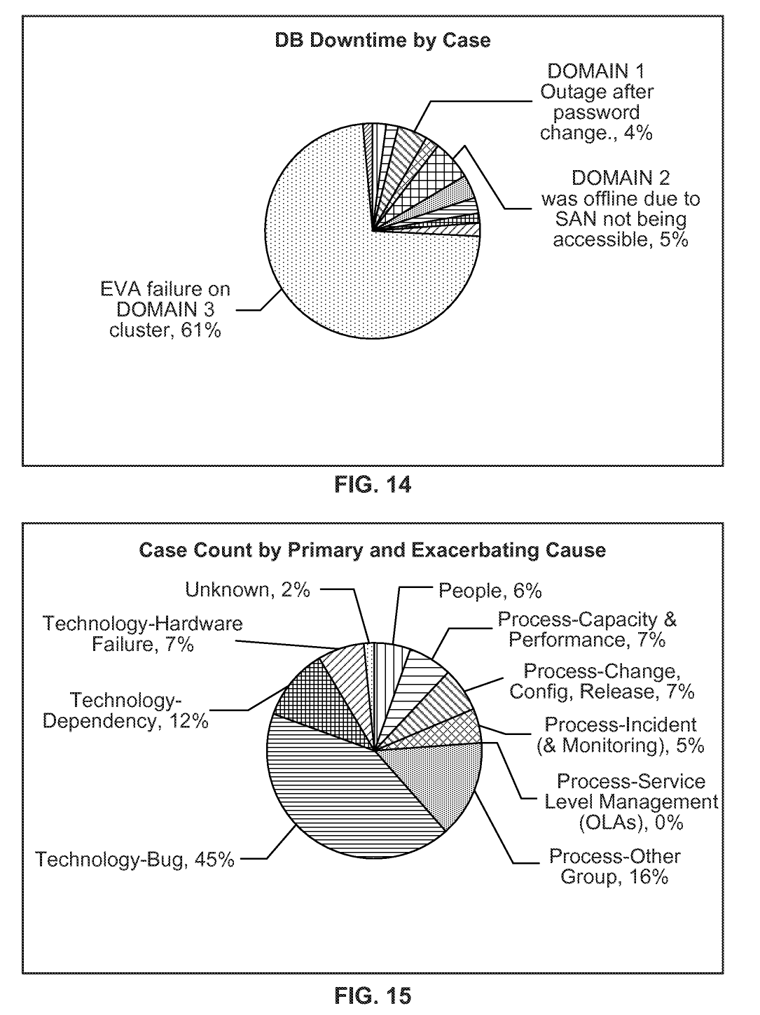

FIG. 13 and FIG. 14 likewise illustrate the server down time and database down time by case. FIG. 13 provides a micro view of the server down time by case and once again one would want to pursue the largest area in each time period to ensure that the issues occurring therein do not reoccur.

FIGS. 15-18 provide a distribution of case count, service down time, server down time, and database down time by primary and exacerbating cause, respectively. The case count by primary and exacerbating root cause is a distribution of the case count (the number of NPRs) due to each primary and each exacerbating root case. This view gives us a macro view of the primary and secondary root causes and is concerned more with frequency rather than impact.

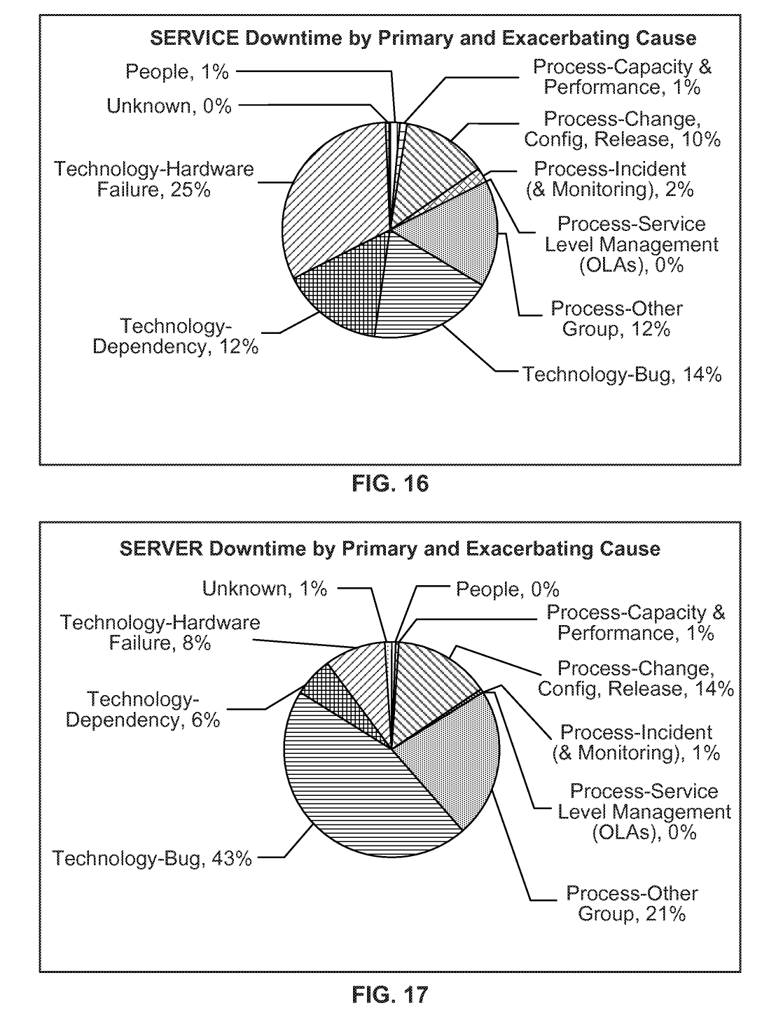

An IT department will focus its resources on the largest percentages of cases that the department can actually impact. For example, these may include items like process capacity and performance, reducing the frequency increases the mean time between failures. Hence, the technology presented herein allows the best practices defined by ITIL® to be made practical, and automates the practices that ITIL® vaguely describes. The service, server, and database down time graphs by primary and exacerbating root cause show the distribution of service, server, and database down time minutes in each primary and exacerbating root cause. For each graph, one calculates the service, server, or database down time for each case due to each primary cause and also due to each exacerbating root cause for each case. Then one sums the total of these columns where the primary and/or secondary cause is attributable to each of the service, server, or database causes. These views give us a macro view of the primary and secondary root causes and their impacts on the service, server, or database. In contrast to the case count graph in FIG. 15, FIGS. 16, 17 and 18 are concerned more with the impact rather than frequency. One would focus an IT department's resources on the largest percentages of cases that one can actually impact. The present technology therefore provides an advantageous means for conducting major problem review process.

Each of the aforementioned tables and graphs can be utilized to show trends in IT management by comparing reports for different periods of time. For example, scorecards consisting of all elements of FIGS. 7-18 may be compared at weekly, monthly and yearly levels to determine the effectiveness of the IT management enterprise at handling major problems.

The technology herein facilitates major problem review by providing IT organizations with a number of tools, including data reporting tools not heretofore known, to manage major problems. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

We claim:

1. A method for reviewing problems in a computing environment, comprising:
organizing the computing environment into a logical representation characterized by groups of elements sharing at least one common characteristic;
identifying data for each incident affecting one or more elements in the computing environment in relation to at least one group of elements; and
storing data for each incident in a common record format including an association of the incident with other groups of elements affected by the change.

2. The method of claim 1 further including storing at least one of a primary root cause and a secondary root cause for each incident.

3. The method of claim 2 further including the step of associating the primary or secondary cause with a people, process or technology cause.

4. The method of claim 3 further including the step of reporting the primary or secondary cause as a function of the people, process or technology causes.

5. The method of claim 3 wherein the common data record includes a people recommendation field, a process recommendation field and a technology recommendation field.

6. The method of claim 1 wherein the common record format includes at least one of a server downtime, a service downtime and/or a database downtime.

7. The method of claim 6 wherein the common record format includes each of a server downtime, a service downtime and/or a database downtime for each incident.

8. The method of claim 6 further including the step of associating each of a server downtime, a service downtime and/or a database downtime with a people, process or technology cause.

9. The method of claim 8 further including the step of reporting each of said server downtime, service downtime and/or database downtime in relation to the a people, process or technology cause.

10. The method of claim 1 wherein the step of recording includes recording at least one action item.

11. A computer-readable medium having stored thereon a data structure, comprising:
(a) a first data field containing data identifying an incident;
(b) at least a second data field associated with the first data field identifying a group of components of an IT infrastructure associated with the incident; and
(c) a third data field identifying at least one root cause for the incident, each root cause being classified as a people cause, process cause or technology cause.

12. The computer readable medium of claim 11 wherein the structure includes at least at least a fourth data field identifying a number of server downtime minutes, a number of service downtime minutes and/or a number of database downtime minutes.

13. The computer readable medium of claim 11 wherein the second data filed identifies one of at least a service impacted, a domain impacted, a datacenter impacted and/or a service component impacted.

14. The computer readable medium of claim 11 wherein the structure includes at least a field identifying a primary root cause and a secondary root cause.

15. The computer readable medium of claim 11 wherein the structure further includes a data field including one of at least a recommendation to correct a people cause of an incident, a recommendation to correct a process cause of an incident, and/or a recommendation to correct a technology cause of an incident.

16. The computer readable medium of claim 11 wherein the structure includes at least one data field including one or more action items.

17. A computer-readable medium having computer-executable instructions for performing steps comprising:
providing an input interface including a common schema for storing incident data in a manner which associates the incident data with one or more elements in the computing environment;
receiving one or more data records recording incidents in the computing environment in relation to at least one group of elements; and
outputting a major problem review scorecard including an analysis of service, server and database downtime.

18. The computer readable medium of claim 17 wherein the step of outputting includes outputting a report indicating one or more of the total service, server and database downtime, and the relative amount of service, server and database downtime in relation to root causes of incidents.

19. The computer readable medium of claim 18 wherein the root causes are classified as a people cause, process cause or technology cause.

20. The computer readable medium of claim 17 wherein the step of outputting includes outputting one or more graphs illustrating incidents in relation to at least one of: a service impacted, a component impacted, and/or server, service and database downtime by case and/or root cause.
